(19) United States
(12) Patent Application Publication
(10) Pub. No.: US 2009/0068391 A1
(43) Pub. Date: Mar. 12, 2009

(54) INFORMATION RECORDING MEDIUM

(76) Inventors: Fung-Hsu Wu, Gueishan (TW); Chun-Nan Chen, Gueishan (TW)

Correspondence Address: HOFFMAN WARNICK LLC, 75 STATE STREET, 14TH FLOOR, ALBANY, NY, 12207, US

(21) Appl. No.: 11/930,237

(22) Filed: Oct. 31, 2007

(30) Foreign Application Priority Data
Sep. 12, 2007 (TW) 096134040

(51) Int. Cl. B32B 3/02

(52) U.S. Cl. 428/64.2

(57) ABSTRACT

The invention discloses an information recording medium comprising a disc body, an ink-receiving layer, and a stacker ring. The disc body comprises a non-data side and a data side. The ink-receiving layer is provided on the non-data side. The ink-receiving layer has an outer radius larger than 57 mm and an inner radius smaller than 20 mm. The stacker ring is located near the center of the data side. The stacker ring has a radius smaller than 11 mm. Specifically, the radius of the stacker ring should be smaller than the inner radius of the ink-receiving layer. Accordingly, a larger area pattern can be printed on the information recording medium of the invention. Furthermore, since the stacker ring does not contact the ink-receiving layer, the information recording medium will not adhere to another under high temperature and high humidity after a period of transportation.

### BACKGROUND OF THE INVENTION

1. Field of the Invention

The invention relates to an information recording medium and, more particularly, to a printable information recording medium which do not adhere to another under high temperature and high humidity after a period of transportation.

2. Description of the Prior Art

A printable information recording media (such as compact disc, digital versatile disc and blu-ray disc) is allowed to print a pattern on an ink-receiving layer of the non-data side by a printer. Recently, printing modes of the printable information recording media can be divided into a general mode (FIG. 1A) and a full-page mode (FIG. 1B). As shown in FIG. 1A and FIG. 1B, for printable information recording media, an inner radius R1 of the ink-receiving layer 10 on a general mode is larger than an inner radius R2 of the ink-receiving layer 20 on a full-page mode. Accordingly, a printed pattern on printable information recording medium 2 is visually a larger area in a full-page mode and further with vision delight.

In general, after manufacturing process of information recording media are finished, the product will be delivered to customers after properly package. Packing modes generally can be divided into pudding barrel packing or plastic membrane packing. By either packing mode, all information recording media are stacked by stacker rings. As shown in FIG. 2, the ink-receiving layer 20 of the printable information recording media 2 in the conventional full-page mode will contact the stacker ring 22. For conventional compact disc, the radius of the stacker ring 22 is about 19 mm.

Because delivering printable information recording media are usually by sea transportation, testing of information recoding media is simulated in a chamber with high temperature (about 70° C.) and high humidity (about 75%). However, due to the interaction between ink and the stacker ring after 24 hours, the printable information recording media in the full-page mode adhere to each other. The package in plastic membrane packing is even more serious.

Because a plastic membrane induces larger stress on the information recording media in the packing process and these information recording media suffer a period of transportation in high temperature and high humidity afterward, ink adheres to the stacker ring, and aforementioned condition of disc adherence is occurred.

Accordingly, the scope of the invention is to provide a printable information recording medium to solve the aforesaid problems.

### SUMMARY OF THE INVENTION

A scope of the invention is to provide a printable information recording medium. When the printable information recoding media are stacked, a stacker ring does not stick an ink-receiving layer below. Moreover, the information recording medium does not adhere to another under high temperature and high humidity after a period of transportation.

According to an embodiment of the invention, the information recording medium comprises a disc body, an ink-receiving layer and a stacker ring. The disc body comprises a non-data side and a data side relative to the non-data side. In practical applications, a pickup head of a drive is used for writing data into the data side, reading data from the data side or both.

The ink-receiving layer is provided on the non-data side. The ink-receiving layer has an outer radius larger than 57 mm and an inner radius smaller than 20 mm. The stacker ring is located near the center of the data side, and the stacker ring has a radius smaller than 11 mm. Particularly, the radius of the stacker ring should be smaller than the inner radius of the ink-receiving layer. Accordingly, a larger area pattern can be printed on the information recording medium of the invention. Furthermore, since the stacker ring does not contact the ink-receiving layer, the information recording medium does not adhere to another under high temperature and high humidity after a period of transportation.

The advantage and spirit of the invention may be comprehended by the following recitations together with the appended drawings.

### BRIEF DESCRIPTION OF THE APPENDED DRAWINGS

FIG. 1A is a schematic diagram illustrating a printable information recording medium in a general mode.

FIG. 1B is a schematic diagram illustrating a printable information recording medium in a full-page mode.

FIG. 2 is a schematic diagram illustrating a stack of a printable information recording medium in a full-page mode.

FIG. 3A is a schematic diagram illustrating an information recording medium according to an embodiment of the invention.

FIG. 3B is a schematic diagram illustrating another viewpoint of the information recording medium shown in FIG. 3A.

FIG. 4 is a cross-sectional view illustrating the information recording medium shown in FIG. 3A along line A-A.

FIG. 5 is a schematic diagram illustrating a stack of information recording media.

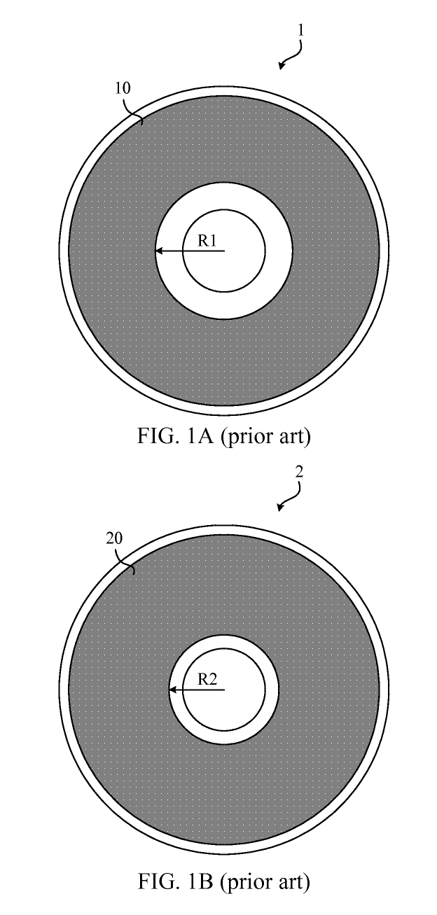

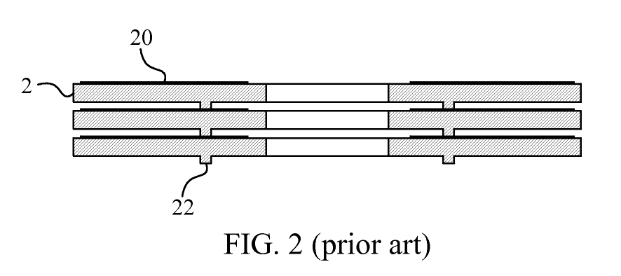

### DETAILED DESCRIPTION OF THE INVENTION

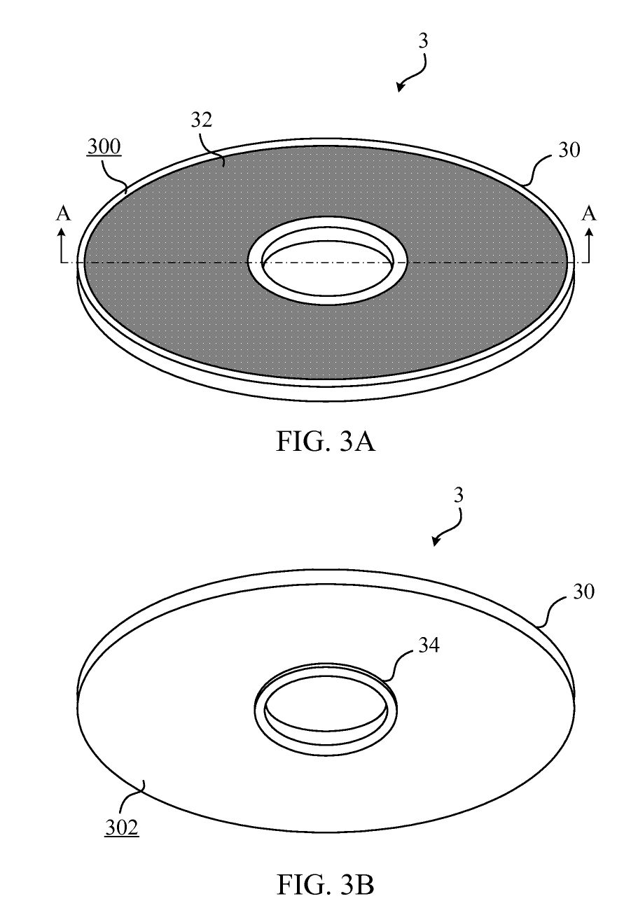

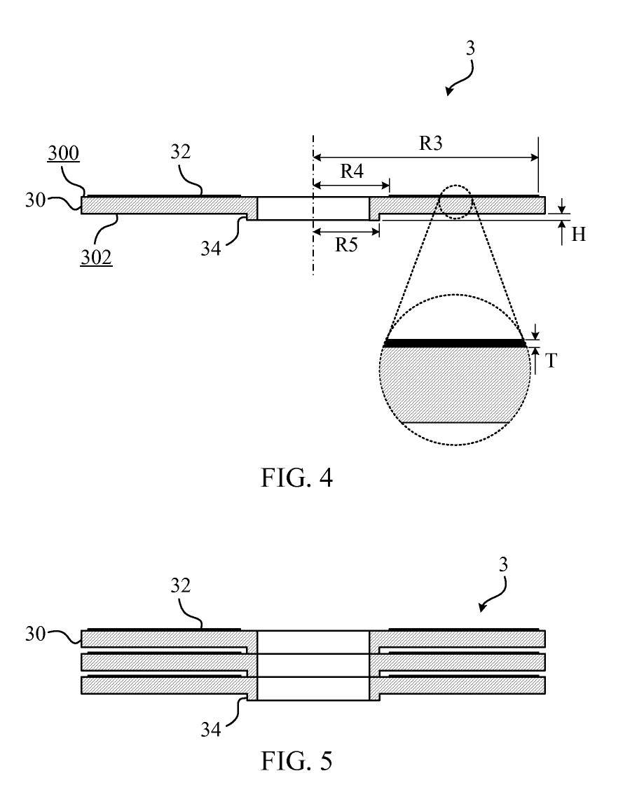

Please refer to FIG. 3A and FIG. 4. FIG. 3A is a schematic diagram illustrating an information recording medium 3 according to an embodiment of the invention. FIG. 3B is a schematic diagram illustrating another viewpoint of the information recording medium 3 shown in FIG. 3A. FIG. 4 is a cross-sectional view illustrating the information recording medium 3 shown in FIG. 3A along line A-A.

As shown in FIG. 3A and FIG. 3B, the information recording medium 3 comprises a disc body 30, an ink-receiving layer 32 and a stacker ring 34. The disc body 30 comprises a non-data side 300 and a data side 302. The ink-receiving layer 32 is provided on the non-data side 300. The stacker ring 34 is located near a center of the data side 302.

In this embodiment, the information recording medium 3 can be compact disc, digital versatile disc and blu-ray disc. In practical applications, a pickup head (not shown) of a drive (not shown) is used for writing data into the data side 302 or reading data from the data side 302. Users can print a pattern on the ink-receiving layer 32 by utilizing a printer (not shown).

As shown in FIG. 4, the ink-receiving layer 32 has an outer radius R3 and an inner radius R4, and the stacker ring 34 has a radius R5. In this embodiment, in order to allow a larger printed-pattern area on the information recording medium 3, the outer radius R3 of the ink-receiving layer 32 is designed to be larger than 57 mm, and the inner radius R4 is designed to be smaller than 20 mm.

Furthermore, the radius R5 of the stacker ring 34 is designed to be smaller than 11 mm, and the radius R5 of the stacker ring 34 should be smaller than the inner radius R4 of the ink-receiving layer 32. Therefore, when packing information recording media 3, every stacker ring 34 does not contact the ink-receiving layer 32 below it, as shown in FIG. 5. Since the stacker ring 34 does not contact the ink-receiving layer 32 below it, the information recording medium does not adhere to another under high temperature and high humidity after a period of transportation.

In this embodiment, a thickness T of the ink-receiving layer 32 is designed between 10 μm and 50 μm, and a height H of the stacker ring 34 can be designed to be between 50 μm and 200 μm.

Compared with the prior art, because the outer radius of the ink-receiving layer is larger than 57 mm and the inner radius is smaller than 20 mm, a larger printed-pattern area can be shown on the information recording medium of the invention. Besides, because the radius of the stacker ring is smaller than 11 mm and the radius of the stacker ring is smaller than the inner radius of the ink-receiving layer, the stacker ring does not contact the ink-receiving layer while packing information recording media together. Accordingly, the information recording medium will not adhere to another under high temperature and high humidity after a period of transportation.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An information recording medium, comprising:
a disc body comprising a non-data side and a data side; and
a stacker ring, located near a center of the data side, having a radius smaller than 11 mm.

2. The information recording medium of claim 1, further comprising an ink-receiving layer on the non-data side.

3. The information recording medium of claim 2, wherein the ink-receiving layer has an outer radius larger than 57 mm and an inner radius smaller than 20 mm.

4. The information recording medium of claim 3, wherein the radius of the stacker ring is smaller than the inner radius of the ink-receiving layer.

5. The information recording medium of claim 1, wherein a thickness of the ink-receiving layer is between 10 μm and 50 μm.

6. The information recording medium of claim 1, wherein a height of the stacker ring is between 50 μm and 200 μm.
